(19) United States
(12) Patent Application Publication
(10) Pub. No.: US 2003/0096162 A1
(43) Pub. Date: May 22, 2003

(54) Lithium-ion battery seal

(76) Inventors: Brian J. Lasater, East Wenatchee, WA (US); Joseph H. Schulman, Santa Clarita, CA (US); Gary D. Schnittgrund, Granada Hills, CA (US)

Correspondence Address: ALFRED E. MANN FOUNDATION FOR, SCIENTIFIC RESEARCH, PO BOX 905, SANTA CLARITA, CA, 91380, US

(21) Appl. No.: 10/290,140

(22) Filed: Nov. 7, 2002

Related U.S. Application Data
(60) Provisional application No. 60/346,031, filed on Nov. 9, 2001.

(51) Int. Cl. H01M 2/08

(52) U.S. Cl. 429/184; 29/623.2; 29/623.4

(57) ABSTRACT

The invention is a hermetic seal that is compatible with lithium-ion electrolyte in lithium batteries. Pin feed throughs are sealed by compression, chemical bonding, and mechanical bonding between the metal pin and a sealing glass, such as Cabal-12. The pin may be coated with a metal or a metal oxide to enhance compatibility with the lithium battery environment. The pin surface is roughened or mechanically shaped to ensure mechanical bonding with the glass seal. Mechanical bonds are also achieved by placing the pin/glass seal interface in compression by an external compression band.

### CROSS REFERENCE TO RELATED APPLICATION

This application claims the benefit of U.S. Provisional Application No. 60/346,031, filed Nov. 9, 2001.

### FIELD OF THE INVENTION

The present invention is generally directed to forming glass-to-metal seals that are of particular use when hermeticity is required for very long exposures to harsh environments. These seals can be used for the glass-to-metal seals in components exposed to severe chemical environments, e.g., in headers for ambient temperature lithium-ion batteries.

### BACKGROUND OF THE INVENTION

Hermetic seals are often used for harsh environmental applications.

They are used to present a barrier that protects sensitive electronic hardware components from outside environmental conditions, which would otherwise destroy the hardware components. In the case of medical devices, hermetic seals can also protect living tissue from electronic components. The problem is to manufacture the hermetic seal as ruggedly as possible for applications where hermeticity will be required for extended exposures to harsh environments.

Ambient temperature lithium batteries provide high energy densities and high rate capabilities, at low temperatures; however, a major problem associated with these cells is the highly corrosive nature of lithium chemistry. Standard glass insulators, used to separate the header of a battery header from the center pin while providing a hermetic seal for the battery, experience extensive corrosion over relatively short periods of time, thus severely limiting the shelf life of the cells.

An additional problem associated with conventional lithium batteries is encountered if one uses molybdenum as the pin material for center pins in lithium battery headers. Molybdenum is a difficult material to work with, being difficult to weld, difficult to machine as it is very brittle, and susceptible to aqueous corrosion. It is desirable to use alternative pin materials, instead of molybdenum. Replacement of molybdenum with more weldable, more machinable, and more chemically resistant alloys would improve both the ability to manufacture lithium batteries and their ultimate performance. Improved pin materials for lithium batteries include Alloy-52 and 446 stainless steel. Alloy 52 is a Ne—Fe alloy also referred to as Niron 52; Niron 52 is described a magnetic alloy of 50% nickel and 50% iron, having the following properties: density of 8.46 gm/cm³, and tensile strength of 70,000 psi. Alloy 52 or Niron 52 has a linear thermal expansion coefficient (CTE) of 9.8×10⁻⁶/°C. at room temperature to 500C. Niron is an expired trademark of Wilbur B. River Company, N.J. The 446 stainless steel is the AISI designation for a ferritic steel which is magnetic and non-heat treatable, having a linear CTE of 11.4×10⁻⁶/°C. at room temperature to 700C; also, 446 stainless steel is a ferritic steel with 23-27% chromium content, 0.20% maximum carbon content, and 0.25% maximum nitrogen content, typically used in applications requiring high resistance to corrosion and oxidation.

In order to form an acceptable glass-to-metal seal in an ambient temperature lithium battery, the glass must meet three main criteria. First, it must have a high resistance to lithium corrosion; second, it must be able to make a hermetic seal between the metal header and the metal center pin, which requires an expansion match between the glass and the pin; and, third, it must be an electrical insulator so that the header and the center pin are electrically isolated.

Also, where feedthroughs are utilized in connection with body implanted devices, where the electrical terminals may come into contact with body fluids, it is necessary to choose terminals or pins made of bio-stable materials since there is the possibility of hydrogen embrittlement occurring, especially at the negative terminal in a lithium-ion battery.

One glass used in the glass-to-metal seal in headers for lithium ambient temperature batteries is TA-23, which has a finite corrosion rate when in contact with lithium metal that limits the lifetime of the battery.

Glasses based on the CaO—Al203-B2O3 and CaO—MgO—Al₂O₃-B₂O₃ systems have been developed to improve the corrosion resistance and extend the battery lifetime. A promising glass is Cabal-12, which was developed by Sandia National Laboratories and which exhibits corrosion resistance. Although this glass has desirable corrosion resistance and resistance to cracking, many metals do not wet the glass allowing strong, hermetic seals nor do they exhibit weldability or desired thermal expansion characteristics. Like TA-23, it is designed to have a thermal CTE that closely matches that of the molybdenum center pin, about 6.0×10⁻⁶/°C. Cabal-12 has far superior corrosion resistance than TA-23, but all of the CaO—Al₂O₃—B₂O₃ and CaO—MgO—Al₂O₃—B₂O₃ glasses have limited thermal CTE ranges, on the order of 6.0-9.0×10⁻⁶/°C., which makes them unsuitable for sealing to high CTE metal pin materials.

U.S. Pat. No. 5,015,530 describes glass-to-metal seals for use in lithium electrolyte environments, using glass compositions that seal hermetically with higher expansion, metal pin materials other than molybdenum. Alkaline earth-aluminoborate glass formulations, based on the (CaO, SrO, BaO)—B₂O₃—Al₂O₃ systems and high expansion metal pin materials are discussed. The glasses are boroaluminate glasses with SrO and BaO substituted for the CaO and MgO used in Cabal-12, and a CaO—B₂O₃—Al₂O₃ glass, having thermal CTEs that match the pin materials, while resisting to attack by lithium. The composition of these glasses is adjusted to achieve a thermal CTE between 9.0 and 12.0 10⁻⁶/°C., allowing hermetic seals to high CTE pin materials, such as 446 stainless steel (CTE of 11.4×10⁻⁶/°C.) and Alloy-52 (CTE of 9.8×10⁻⁶/°C.).

U.S. Pat. No. 5,821,011 addresses a similar problem for body implants of bio-stable materials. The glass insulator is a Cabal-12 type glass. The terminal is comprised of a material that has CTEs compatible with the glass seal. For glass seals having a CTE in the range of 6.8-8.0×10⁻⁶ /°C. the terminal is a thin layer of titanium clad over niobium or tantalum. For glass seals having a thermal expansion in the range of 8.0-9.0×10⁻⁶/°C. the terminal is platinum, platinum-iridium, their alloys, or pure titanium.

U.S. Pat. No. 5,851,222 discusses centerless grinding of pins for lithium batteries for implantable medical devices where the pin may be platinum wire, stainless steel, aluminum, tantalum, niobium, and titanium. TA-23 and Cabal-12 sealing glasses are discussed.

### SUMMARY OF THE INVENTION

The present invention is directed to the formation of seals that are of particular use when hermeticity must be retained for long exposures to harsh environments.

Lithium-ion batteries, for example, contain a very corrosive electrolyte.

A lithium-ion battery in a conventional application may not require true hermeticity because the battery will “wear out” before the seal does.

However, the use of these batteries for rechargeable applications demands that the battery remain hermetically sealed and that the battery keep the electrolyte from escaping the battery package for longer terms. Due to the potential for hydrogen embrittlement or chemical attack by the electrolyte, lithium-ion battery seals occasionally require the use of platinum pin materials. Platinum pins in a glass-to-metal seal, normally, are fabricated as a compression seal. When a Cabal-type glass is used with a platinum pin, it is not a compression seal because the Cabal-type glass has a lower coefficient of thermal expansion (CTE) than the platinum. This leads to tensile stresses developing at the glass to pin interface that, in turn, lead to leaking seals. The second problem with lithium-ion battery hermetic seals of glass to platinum pins is the lack of any chemical bonding of the glass to the pin. Platinum is known to be chemically inert. It has been demonstrated that it is possible to push on the end of a pin in a sealed assembly and slide the pin out of the seal with little or no damage to the sealing glass.

In other hermetic applications, such as seawater, saline, in vivo and/or implantable devices and the like, a different set of materials may be used to facilitate the hermetic seal. However, the same essential problem remains.

First, it is difficult to find good lithium-ion chemically resistant glasses or glass-ceramics that have higher CTE values than platinum or platinum alloys. Second, even though many metallophillic glasses will readily wet most metals, the exception is platinum. Platinum has long been used for glass melting as an inert container or a lining of the ceramic crucible used in the melting of glasses. Platinum prevents the glass from reacting with the crucible walls and the platinum does not react with the glass. Therefore, even though a much wider glass selection is available for seals exposed to seawater, saline, in vivo and/or in vitro type medical devices, the same problem remains of non-wetting of the platinum pin.

The object of this invention therefore, is to disclose methods of making optimum hermetic seals with platinum pins, platinum alloy pins or any other metal pins used in glass-to-metal seals, using a Cabal-type glass or other suitable glass, glass-ceramic. Titanium, titanium alloy, stainless steel or any suitable header material that is resistant to lithium-ion chemistry, seawater, saline or bodily fluids, may be used for the header of the seal.

The invention will be best understood from the following description when read in conjunction with the accompanying drawings.

### OBJECTS OF THE INVENTION

It is an object of the invention to bond a platinum pin in a glass-to-metal seal for corrosive environments.

It is an object of the invention to achieve a compression bond in a glass-to-metal seal for corrosive environments.

It is an object of the invention to provide a chemical bond in a glass-to-metal seal for corrosive environments.

It is an object of the invention to provide a mechanical bond in a glass-to-metal seal for corrosive environments.

It is an object of the invention to achieve a glass-to-metal seal in a lithium-ion battery.

Other objects, advantages and novel features of the present invention will become apparent from the following detailed description of the invention when considered in conjunction with the accompanying drawing.

### BRIEF DESCRIPTION OF THE DRAWINGS

FIG. 1 is a feedthrough suitable for a lithium-ion battery application as found in the prior art.

FIG. 2 is an improved feedthrough utilizing platinum family metals and a low thermal expansion core.

FIG. 3 is an improved feedthrough with a wettable oxide coating in the sealed area.

FIG. 4 is an improved feedthrough with a chemical bonding layer in the sealed area.

FIG. 5 is an improved feedthrough utilizing abrasion prior to applying a chemical bonding layer to the pin.

FIG. 6 is an improved feedthrough with mechanical interlocking pin.

FIG. 7 is an improved feedthrough with a low expansion pin having the protective coating removed in the sealed area.

FIG. 8 is an improved feedthrough with high expansion bushing.

FIG. 9 is an improved feedthrough with high expansion header.

FIG. 10 is an improved feedthrough with a protective covering on the pin ends.

### DETAILED DESCRIPTION OF THE PREFERRED EMBODIMENTS

The following description is of the best mode presently contemplated for carrying out the invention. This description is not to be taken in a limiting sense, but is made merely for the purpose of describing the general principles of the invention.

The present invention is directed to improved techniques for generating a hermetic seal that is particularly rugged such that hermeticity can be maintained for extended periods in harsh environments, such as implantable medical devices in living tissue.

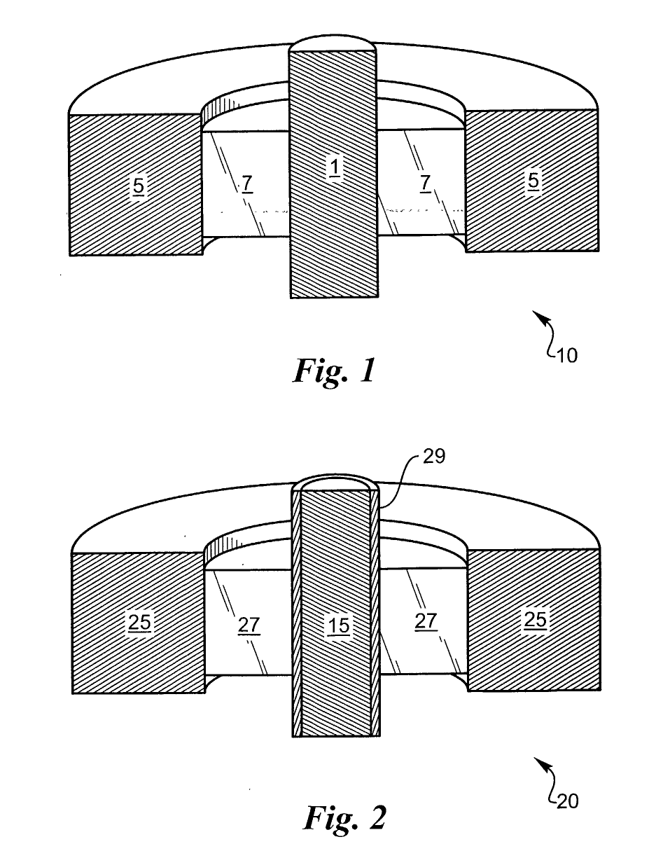

In a typical lithium-ion sealing bonded assembly 10, titanium, titanium alloy or any lithium-ion resistant metal will form the header 5 (see FIG. 1). Cabal-12 sealing glass 7 is a standard in the industry at the current state of the art. Other Cabal “family” formulations are commercially available and are described in U.S. Pat. No. 5,104,738. The pin 1 used in the preferred seal is platinum or platinum alloy, due to the aforementioned reasons regarding chemical corrosion resistance. Typical sealing glass compositions are listed below.

Sealing Glass Candidates and Corrosion Results
After U.S. Pat. No. 5,015,530

| | Formula | Days Before |
|---|---|---|
| Name | (mole %) | Corrosion |
| Babal-1 | 50 BaO-40 B₂O₃-10 Al₂O₃ | >14 |
| Babal-2 | 40 BaO-40 B₂O₃-20 Al₂O₃ | >30 |
| Babal-1C | 30 CaO-20 BaO-40 B₂O₃-Al₂O₃ | 45 |
| Babal-1D | 40 CaO-10 BaO-40 B₂O₃-10 Al₂O₃ | 90 |
| SrBAL-4 | 30SrO-50 B₂O₃-10 Al₂O₃ | 70 |
| TA-23 | 14.16 CaO-11.49 MgO-3.83 SrO-0.4 | 3-6 |
| | La₂O₃-49.54 SiO₂-12.98 Al₂O₃-7.6 | |
| | B₂O₃ | |
| Cabal-12 | 20 CaO-20 MgO-20 Al₂O₃-40 B₂O₃ | 30-60 |

In the following discussion, reference to Cabal-12 and Cabal-12-type sealing glasses refers to sealing glasses as presented generally above.

This sealing scenario is fundamentally flawed in two regards. First, the design of glass-to-metal seals generally requires that the sealing glass 7 have a higher coefficient of thermal expansion (CTE) than the pin 1. This enables the bonded assembly 10, when cooled from the sealing temperature to room temperature, to have a net compressive stress within the seal.

Significantly, since glasses are weak in tension, any net tensile stresses can lead to failure of the seal. In the case of the titanium header 5, Cabal-type sealing glass 7 and the platinum pin 1, the platinum has a higher CTE than the Cabal glass and is therefore an improper seal design.

The other flaw is based upon the desire for the sealing glass 7 to flow and wet to the platinum pin 1. The Cabal-type glass does not wet metals, such as platinum. The Cabal-type sealing glasses will wet titanium, tantalum, aluminum, platinum-aluminide, iridium, rhenium, ruthenium, osmium, palladium, niobium, and molybdenum, for example. The Cabal-type glass will particularly wet the oxides of the above-mentioned metals. Since they do not wet platinum or platinum alloys, they do not exhibit chemical bonding.

This invention addresses the problem in several ways. As shown in FIG. 2, the CTE of the pin 15 in the bonded assembly 20 is selected to be lower that than of the sealing glass 27, yet it is selected to maintain the electrochemical protection. This is done by using platinum, platinum-iridium, iridium, rhenium, rhodium, platinum alloy or platinum family metals as a pin coating 29 that is metallurgically bonded with a lower CTE metal pin core 15, such that the lower CTE of the pin core 15 will yield a seal of proper CTE design considerations. The ratio of platinum metal pin coating 29 to low CTE pin core 15 material may vary, if the lower CTE member in the pin core 15 is the dominant member for thermal expansion characteristics.

Low CTE core materials are molybdenum, tungsten, Invar, Kovar, Alloy 36, Alloy 42, Alloy 46, Alloy 52 or any material that will yield a lower CTE than the Cabal-12 or Cabal family of glasses. The platinum may be applied to the low CTE pin core 15 by cladding, electroplating, sputtering, evaporation, CVD or modified CVD, PVD or modified PVD, explosion welding or any such method that will form a metallurgically-bonded platinum pin coating 29 to low CTE pin core 15.

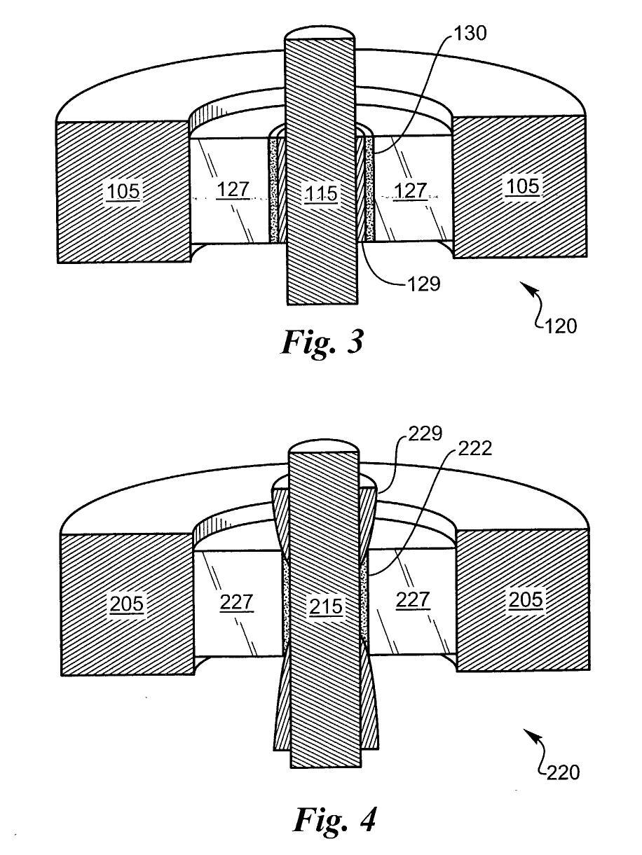

Another embodiment, presented in FIG. 3, is to form a chemical bond at the pin 115 to the Cabal sealing glass 127 interface (see FIG. 5). This is accomplished by applying a pin coating 129 to the pin 115, where the pin 115 is preferably platinum, with the pin coating 129 known to be wettable by Cabal-type glass. Known pin coating 129 metals are titanium, aluminum, platinum-aluminide, iridium, rhenium, ruthenium, osmium, palladium, niobium, chromium, or tantalum, alone or in combination with each other.

As an alternative embodiment to that presented in FIG. 3, any of the pin coating 129 metals may be used in the oxide form as oxide layer 130 to enhance the chemical bonding to the sealing glass 127. In addition to the above named metals, platinum may be included in its oxide form since the oxide is wetted by Cabal-type glasses. Formation of the oxide coating is accomplished by known methods, such as thermal oxidation of the surface of the pin coating 129 to a metal oxide layer 130 by reactive sputtering or by electrochemical means. Electrochemically, this is accomplished by treatment in a solution and applying a voltage.

Another preferred method of achieving a bonded assembly 220 is with a compression bond (see FIG. 4). The pin 215 is made of a metal selected from los CTE metals, such as molybdenum, tungsten Invar, Kovar, Alloy 36, Alloy 42, or any material with a lower CTE than Cabal-12. The sealing glass 227 is preferably Cabal-12. The header 205 is any of the conventional materials that are known to work in the lithium-ion batter application. The low CTE pin 215 is protected from the aggressive environment by coating 229. The coating may be selected from a non-wetting metal such as platinum, platinum-iridium, platinum-alloy, or platinum family metals or it may be selected from a wetting metal such as titanium, aluminum, platinum-aluminide, iridium, rhenium, ruthenium, osmium, palladium, niobium, chromium, tantalum, or any combination of these metals or their oxides. The wetting metals not only are bonded as a compression bond by virtue of the CTE differential between the pin 215 and the sealing glass 227, but they also form a chemical bond with sealing glass 227.

Pin 315 may be retained in sealing glass 327 to form a sound bonded assembly 320 via chemical bonding along the interface between sealing glass 327 and pin 315. As presented in FIG. 5, a strong compression bond is complemented with a chemical bond by making pin 315 of a low CTE material as previously discussed. Sealing glass 327 is preferably Cabal-12 and header 305 is a conventional material. Pin 315 is protected from the environmental effects by pin coating 329, which is preferably platinum or a platinum alloy as discussed earlier. The compressive bond is complemented in an alternative embodiment by removing or coating over the pin coating 329 in the sealing interface between pin 315 and sealing glass 327. Coating 322 is applied to pin 315 in the interface, the coating 322 is preferably selected from group of wetting materials or oxides as discussed previously, such that a strong chemical bond is formed between sealing glass 327 and coating 322.

Yet another embodiment is presented in FIG. 5, when the pin coating 329 is removed from pin 315 by abrasion. This results in an abraded pin surface 331 that may be coated by conventional means with coating 322.

The resulting abraded pin surface 331 interacts with the sealing glass 327 to form a strong chemical bond as well as a mechanical bond.

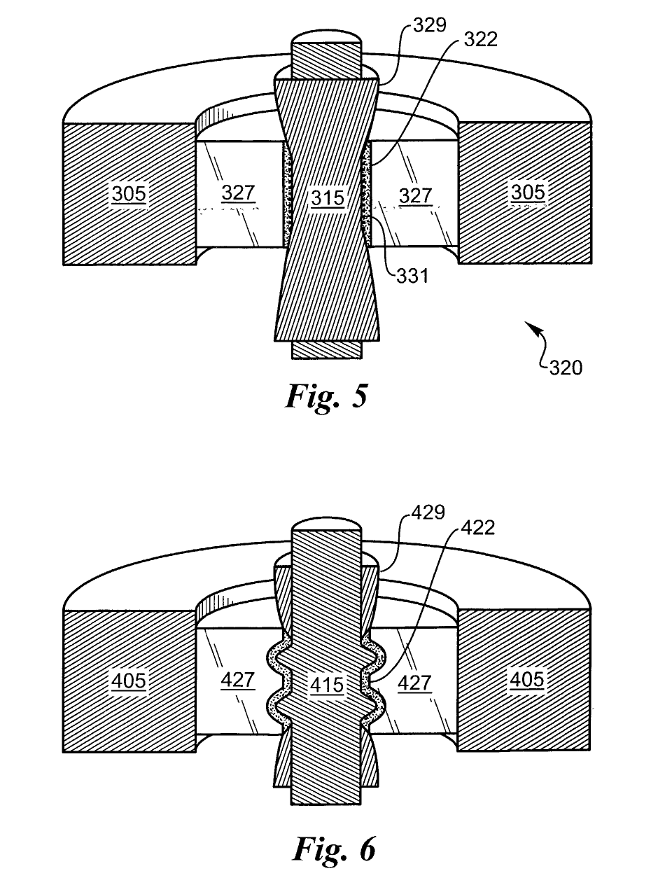

A further alternative embodiment to achieve a competent seal is presented in FIG. 6, where a strong mechanical bond is achieved by deforming the pin 315. The header 405 is made of a conventional material.

Sealing glass 427 is preferably Cabal-12. The mechanical deformation of pin 415 is formed as ridges or deformations that make the pin 415 adhere mechanically in sealing glass 427. A further advantage of ridges are that they increase the leakage path length along the interface between pin 415 and sealing glass 427.

While the pin may be made of a conventional material such as platinum, yet a further alternative embodiment is presented in FIG. 6 when a pin coating 429, such as platinum, is applied to a low CTE pin 415 material.

As presented in FIG. 6, an alternative embodiment is to remove the pin coating 429 in the sealing area and apply a coating 422 of a wettable metal, selected as previously discussed, by conventional means. In this manner, there is both a strong chemical bond and a strong mechanical bond retaining the pin 415 is the sealing glass 427.

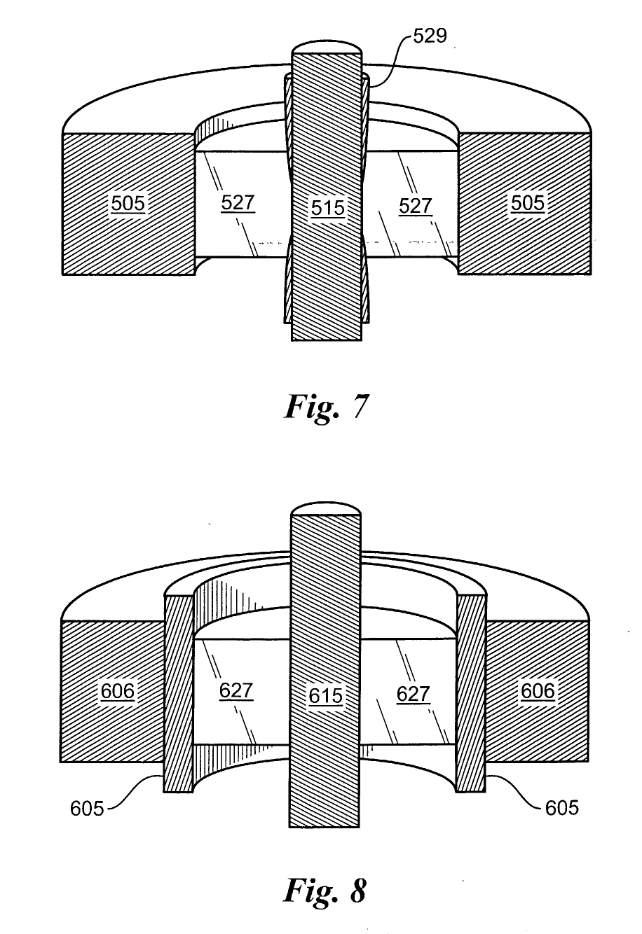

Another preferred embodiment is presented in FIG. 7, where pin 515 is retained in sealing glass 527 by a compression seal that is formed by virtue of pin 515 being a low CTE material, where, as previously discussed, the pin 515 CTE is less than that of the sealing glass 527, which is preferably Cabal-12. Header 505 is selected from know materials. Pin 515 is coated with pin coating 529 to afford it protection from environmental damage, where the pin coating 529 is platinum or a similar material, as previously discussed. In this embodiment, pin 515 is made of a low CTE material that bonds with the sealing glass 527, hence the pin coating 529 is removed by means previously discussed to place pin 515 in contact in the seal area of the pin 515. Materials that have a low CTE and that exhibit good wetting and therefore good bonding characteristics with typical sealing glass 527 materials include titanium, aluminum, platinum-aluminide, iridium, rhenium, ruthenium, osmium, palladium, niobium, chromium, and tantalum, or their combination and their oxides.

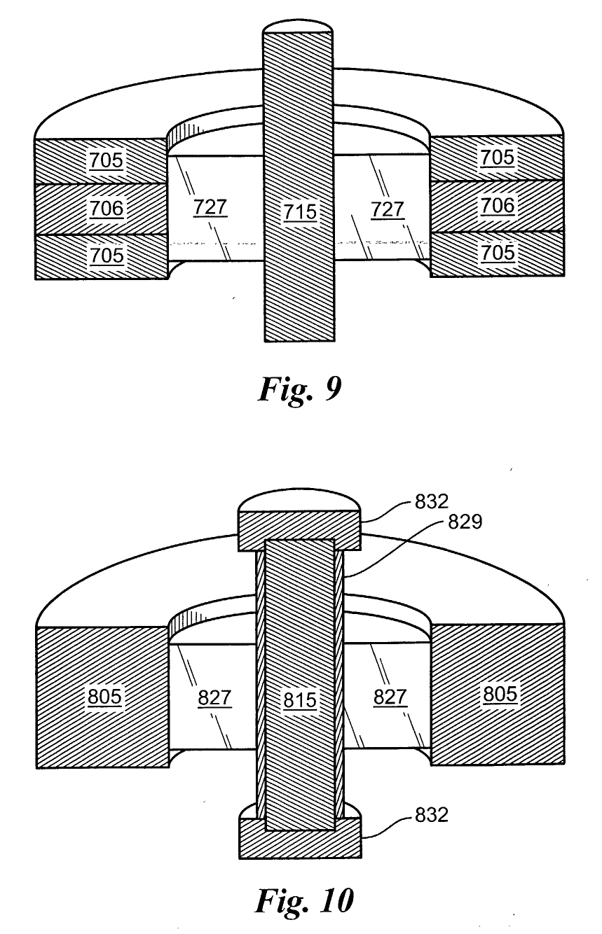

The glass-to-metal seal is further improved by increasing the compression within the seal by adding or substituting a high CTE metal to the sealing area of the feedthrough (see FIGS. 8 and 9). Adding a 300-series stainless, such as 316 or 304 stainless, or 400-series stainless, Glidcop™ (a dispersion strengthened copper) (Glidcop is a former registered trademark of SCM Corporation), or other high CTE metal bushing 606 around a thin header 605, where the header 605 is made of a conventional material, such as titanium. The pin 615 may be made of either a conventional high CTE material such as a platinum type material or it may be made by one of the previously discussed methods that use a low CTE material. As the seal is cooled from its bonding temperature, the high CTE 606 bushing shrinks thereby placing the sealing glass 627 and pin 615 in compression at the seal area.

An alternative embodiment to this compression bond is presented in FIG. 9, where the seal, alternatively, may be fabricated using the high CTE materials discussed for bushing 616. In this embodiment, the clad material of titanium-stainless-titanium is formed of header 705 on the top and bottom surfaces that surround bushing 706 of a high CTE material, thus providing the upper and lower surfaces exposed to the harsh environments of a protective material, while the high CTE bushing 706 provides the high compressive force required for maximum sealing reliability between pin 715 and sealing glass 727. It is known in the art that Cabal-type glass materials will wet stainless steel, which enhances the sealing effectiveness at the sealing glass 727 interface with the sealing glass 727.

Finally, embodiments of the present invention (see FIG. 10) include a cap 832 for the end of the pin 815. This is required in a harsh chemical environment, such as that encountered in lithium-ion chemistry. If the low CTE material at the center of the pin 815 is exposed to the chemicals, a corrosion process will begin. Therefore, it is important to fashion a “cover” as cap 832 on the end of the pin. The cap 832 can be platinum or, preferably, the same material as the pin coating 829 that bonds with sealing glass 827. The cap 832 is inserted on the end of the pin and laser or resistance welded to the pin 815. The cap 832 may simply be a piece of foil that is then welded to the end of the pin 832. The end of the pin 815 may also be coated by electroplating a protective coating of, for example, platinum or iridium. The pin 832 may be coated by sputtering, evaporation, e-beam deposition, CVD and modified CVD, PVD, and modified PVD.

Accordingly, what has been shown are techniques for forming hermetic seals, suitable for a lithium-ion battery or the like, that are particularly rugged and thus can maintain hermeticity for extended periods in a harsh environment. While the invention has been described by means of specific embodiments and applications thereof, it is understood that numerous modifications and variations could be made thereto by those skilled in the art without departing from the spirit and scope of the invention.

What is claimed is:

1. A glass-to-metal seal compatible with a lithium-ion electrolyte, comprising:
a pin having a pin coefficient of thermal expansion;
a glass seal having a glass coefficient of thermal expansion; and
said glass coefficient of thermal expansion is greater than said pin coefficient of thermal expansion.

2. The glass-to-metal seal according to claim 1, wherein said pin is comprised of a material from the group consisting of molybdenum, tungsten, Invar, Kovar, Alloy 36, and Alloy 42.

3. The glass-to-metal seal according to claim 1, wherein said glass seal is comprised of a material from the group consisting of Cabal-12, Cabal-type, Babal, and strontium-Babal.

4. The glass-to-metal seal according to claim 1 further comprising:
a coating material that is selected to protect said pin from said lithium-ion electrolyte; and
said coating material is selected from the group consisting of platinum, iridium, platinum-iridium, and platinum alloy

5. A method of forming a glass-to-metal seal compatible with lithium-ion electrolyte, comprising:
selecting a glass seal material having a glass coefficient of thermal expansion and a softening point;
selecting a pin that is comprised of a pin material having a pin coefficient of thermal expansion;
selecting a pin coating material from the group consisting of platinum, iridium, platinum-iridium, and platinum alloy;
selecting said pin material and said glass seal material such that said glass coefficient of thermal expansion is greater than said pin coefficient of thermal expansion;
selecting said pin material from the group consisting of molybdenum, tungsten, Invar, Kovar, Alloy 36, and Alloy 42;
selecting said glass seal material from the group consisting of Cabal-12, Cabal-type, Babal, and strontium-Babal;
placing a thin coating of said pin coating material on said pin to form a coated pin;
forming a bonded assembly by placing said coated pin in said glass seal at a temperature above said softening point of said glass seal material; and
cooling said bonded assembly to a temperature below said softening point of said glass seal material.
